(19) United States
(12) Patent Application Publication
(10) Pub. No.: US 2009/0076941 A1
(43) Pub. Date: Mar. 19, 2009

(54) Transaction Payment Instrument

(76) Inventors: Daniel H. Schneierson, Passaic, NJ (US); Robert E. Levitz, Jerusalem (IL)

Correspondence Address: JOHN ALEXANDER GALBREATH, 2516 CHESTNUT WOODS CT, REISTERSTOWN, MD, 21136, US

(21) Appl. No.: 11/857,456

(22) Filed: Sep. 19, 2007

(51) Int. Cl. G06Q 40/00

(52) U.S. Cl. 705/37; 705/39

(57) ABSTRACT

A transaction payment instrument, used in purchasing a retail quantity of a fungible commodity; the instrument comprising (I) a prepaid commodity portion and (II) a promissory cash-equivalent portion. Preferably, the prepaid commodities portion is backed by futures and/or options for the fungible commodity. The promissory cash-equivalent portion is cash, check, credit card, cash card, prepaid commodity unit card, proof of identity for conducting a commercial transaction, or the likes. The transaction between the customer and the retailer typically includes the customer (A) causing commodity credits to be transferred to the retailer wherein this transfer represents the customer bartering a substantially identical quantity and quality of a commodity with the retailer in exchange for that quantity and quality of that commodity; and (B) paying the retailer for all peripheral charges associated with the physical delivery of the physical commodity—and these charges may include refining, processing, distribution, marketing, tax, etc.

### FIELD OF THE INVENTION

The present invention generally relates to a transaction payment instrument for electronically facilitating purchasing of a substantially fungible commodity, wherein one portion of the actual purchase is substantially accomplished by barter and a second portion of the purchase is substantially accomplished by payment of cash or cash equivalent. More specifically, the present invention relates to a commodity purchase in terms (firstly) of an electronic replacement of the commodity per se, and (secondly) of cash payment for all valued added service components peripheral to the commodity—such as delivery, storage, marketing, management, profit, tax, etc.

### BACKGROUND OF THE INVENTION

Numerous concepts, methods, schemes, and systems are to be presented in order to appreciate the economic reality that creates a backdrop to the needs for and novelty of the instant invention, and the components of that invention. In this context, one aspect of a business method is to provide a likely economic advantage for a commodity user (e.g. retail customer), and/or for retailers, distributors, suppliers, or other parties in the commodity value chain.

For example, regarding the case of retail gasoline prices, U.S. patent application #20030033154 (System And Method For Providing A Fuel Purchase Incentive With The Sale Of A Vehicle) states: “ . . . It will be understood that the commodity price of gasoline can be hedged through the purchase of appropriate financial derivatives, including futures contracts and options. However, in addition to the actual gasoline commodity price, there are additional, more volatile costs associated with the delivery of gasoline to the pump. These costs include for example the cost of transportation, the retail margin and both federal and local taxes. No traditional hedges exist for these more volatile costs. Accordingly, there will be many different methods of calculating a consumer program price . . . It will be understood that, in contrast to taxes and shipping costs . . . , fuel oil price variations is one factor that may be hedged through the purchase of future contracts.”

While this application #20030033154 recognizes many innate aspects of the gasoline commodity value chain economic structure, it culminates with embodiments that substantially bundle the overall gasoline purchases of an individual with his vehicle purchase, and then bundles participants in this program into a common hedging program variant embodiment. The application #20030033154 summarizes its scope with the statement: “Automobile incentive programs, particularly those such as the above-described fuel incentive programs that directly lower buyer ownership costs, have recognized benefits to both buyers and sellers. Because automobile sales represent a significant portion of consumer transactions in many countries, such incentive programs have the further benefit of improving the overall economy.”

More particularly, this application #20030033154 relates to “ . . . methods and systems that enable a manufacturer or other vehicle distributor to effectively provide a vehicle purchase incentive program that caps or lowers the cost of fuel as an operating cost to the buyer. More particularly, . . . (#20030033154) provides systems and methods for financially hedging and otherwise diminishing the costs and volatilities associated with such incentive programs; . . . whereby various program sponsors can contribute financial value to the incentive system operator in exchange for the establishment of customer accounts; . . . (or) provide(ing) the ability for a customer purchasing fuel under the incentive program to flexibly select a payment mechanism and recognize the fuel purchase incentive.”

Now what is clear from this application #20030033154 and from the general literature is that there is a long felt need for ordinary retail consumers to be able to hedge their risks associated with the price of ordinary regularly consumed commodities, such as gasoline. However, wholesale scale features of the commodities futures market make participation for the ordinary consumer logistically intractable. Accordingly, many schemes and methods have been put forward to bring the benefits of risk mitigation, through commodity futures hedging, closer to the ordinary retail commodity consumer.

Now, another aspect of business methods, that should be appreciated, relates to commodities barter; specifically, the barter of substantially fungible commodities. That is to say, commodities that can be exchanged freely with regard to a few simple physical metrics; such as volume, weight, impurity content, BTU value (e.g. for natural gas), or the likes.

In this context, we turn to “Petroleum Swapping Between Oil Giants” [hereinafter: PSBOG] by David I. Haberman,—Apr. 19, 2002 (Statement submitted to the Federal Trade Commission Second Conference re: Factors that Affect Prices of Refined Petroleum Products)—http://www.ftc.gov/bc/gasconf/comments2/habermandavidijd.pdf. “It has been frequently observed that the petroleum industry is one of the most extensively reported, measured, and analyzed of modern industries. In spite of this, for more than a half century there has existed a singularly persistent and pervasive commercial practice (broadly institutionalized within the industry), which has largely escaped critical public scrutiny. That industry practice . . . is the systematic cooperative reciprocal barter (variously called “swaps” or “exchanges”) of gargantuan bulk supplies of domestic and foreign petroleum between ostensibly-competing giant international oil companies. How and why this practice has so long escaped critical public attention is a mystery when one considers that it not only affects daily many millions of barrels (and billions of dollars) of domestic and international oil commerce, but what is more, such petroleum exchanges have flourished continuously for over 75 years between virtually the same vertically-integrated industry giants.”

PSBOG continues: “The precise origins of reciprocal oil barter, (like the origins of primitive human barter) are probably lost in antiquity. There is no way of knowing exactly when or under what circumstances petroleum barter was first utilized. Nor is that of any significance here. What is more important for present understanding is how, and for what purposes, large-scale, systematic reciprocal supply Exchanges first came into use among the largest oil companies with dominant positions in the industry. Here, history still has much to teach. To answer this question, fortunately, there is an excellent published resource in the FTC's own landmark 1952 Report to a Senate Monopoly Committee entitled “The International Petroleum Cartel.” That Report (foundation for the previously noted Justice Department's International Oil Cartel Case [Cartel Case]), highlights a 1928 document drafted by three top executives of the world's then-largest oil companies, (now known as Exxon, Shell and BP).”

PSBOG goes on: “What is significant about that document, (called “The Achnacarry Agreement”) is that there for the first time the dominant Companies' expressed a clear written basic charter of principles, policies, and procedures for solidifying their joint control of international oil supplies and markets. And prominent among these grand plans were special provisions relating to Exchanges. While world market conditions addressed by the Achnacarry Agreement may have substantially changed since 1928, and while all-encompassing cartel agreements like it may have been inhibited by Cartel Case consent decrees, nevertheless the fact remains that some of those original industry practices, like Exchanges still survive, though in a legal limbo (i.e., neither adjudicated nor specifically enjoined by Cartel Case consent decree). Furthermore, since the FTC's aborted 1973 case likewise failed to adjudicate its Exchange issues, the net result of both Government defaults has been a continuing green light for the practice of Exchanges. Nevertheless, the 1952 FTC Report still stands as a classic historical illustration of powerful companies' candid strategic thinking about the role of supply Exchanges.”

PSBOG then quotes: “Page 204 of the FTC Report highlights objectives of those Exchanges as contemplated by The Achncarry Agreement: Reciprocal exchange of supplies.—In addition to the establishment of a quota system for the division of markets . . . the Achnacarry Agreement also provided for a rather elaborate method of exchanging oil supplies among the various participants. The principle purposes of this exchange were to direct supplies to each market from “the nearest producing area” thereby reducing transportation costs through the elimination of cross hauling, and to minimize the tendency to erect duplicate facilities. Avoidance of duplication was expected to result because the participants, in thus exchanging oil supplies, would tend thereby to share each other's existing facilities, and would tend to limit the erection of new facilities to those necessary to supply the increased requirements of petroleum products in the most efficient manner.”

Now, in our first example (#20030033154), we saw that ordinary retail commodity consumers would like to benefit from hedging of commodities futures—a market that is only cost efficient for wholesale players. Here, in our second example (PSBOG), we see that commodity giants (e.g. oil companies) recognize that costs peripheral to the actual cost of the commodity (e.g. shipping, storage, delivery, etc.) are a significant component of ultimate retail price and the savings of such costs enhance market competitiveness. Accordingly, barter schemes may be used to mitigate some of these price components. In similar fashion, there is a long felt need for ordinary retail consumers to likewise accrue some price relief through the use of similar exchange structures; however, here again, the scale of such transactions makes the economy of scale intractable for the ordinary retail consumer.

In fact, there are many smaller scale barter type organizations—geared to the need of wholesalers, retailers, and even individuals. (e.g. http://www.itatrade.com/trade_faq.asp) However, these organizations are primarily focused on the barter of disparate items—there being little need for the exchange of substantially fungible items outside of the largest scale commodities transaction players.

Taxation authorities are well aware of the existing barter market structures. Quoting from a US-IRS information sheet: “Barter transactions can provide your company with important financial, sales and marketing benefits. Like other transactions, however, barter sales are taxable, and your company must report them to the IRS. This is also true of credits you receive or spend through a barter exchange; regardless of how you use barter credits, they are taxable as though they were cash . . . . The U.S. government considers barter exchanges to be legal third-party record keepers, similar to banks, brokerages and other firms that deal with taxpayer records. Barter exchanges are required to complete and submit Form 1099-B, “Proceeds from Broker and Barter Exchange Transactions,” for each of their members and the IRS. In order for the exchange to complete this form, you'll need to give the broker your taxpayer identification number . . . . As far as the IRS is concerned, barter dollars are identical to real dollars. As a result, you won't get any special tax benefits (or penalties, for that matter) from using a barter exchange. If you conduct any direct barter—that is, barter for another company's products or services—you'll have to declare the fair market value of the items you sold as taxable income . . . . This same-as-cash standard also applies to barter purchases: If a barter purchase is business-related, you can deduct it from your taxes, but if it's for personal use you can't deduct it.”

Now, moving past our first example (#20030033154) and our second example (PSBOG), we see (by virtue of the focus of national taxation authorities) that barter is not just limited to the great mega-corporations and the tiny individuals—but is a well practiced business method throughout all strata of commercial enterprise. Of course, barter is presumably the most ancient business method for the purchase of goods or services. In the intervening millennia of economic history, other vehicles to enable such transactions have been “invented”—such as cash, financial instruments (e.g. checks), credit cards, cash cards, and the likes.

As peculiar as it may seem, in order to properly introduce the background and need for the “Transaction Payment Instrument” of the present invention, we will now proceed with a brief introduction to aspects of cash, financial instruments (e.g. checks), credit cards, cash cards, and the likes—so as to better help in appreciating that there yet remains a long felt need for advancement in the field of retail commodity purchase transactions.

Briefly, cash is a government issued standard of value for use in commercial transactions such as the retail purchase of commodities. Other financial instruments (e.g. checks) are generally predicated on having a cash equivalent—but may be subject to various levels of guarantee, insurance, or risk. According to some aspects checks are like cash, yet according to other aspects they are like promissory notes, while according to still other aspects they are instructions to the bank, which may or may not be revoked.

As a practical matter, credit cards (which once were a kind of check substitute—being effectively printed with a copy for the credit card user, a copy for the merchant, and a copy for the credit card company) have substantially become electronic commerce instruments for dispatching instructions to a financial intuition (the credit card company), which often serves as an intermediary lending institution—much like a bank.

Cash cards are insured prepaid cash designated for purchase of gas & related station sold products and/or services or for other specific purposes. For example, the ExxonMobil Cash Card describes itself as “Better than Cash . . . For Life On the Move—Use it for just about anything at over 13,000 Exxon and Mobil stations nationwide:—Fuel for the Road—Snacks, beverages and convenience items—Car Wash and Repairs—Pay at the Pump” “Use of this card constitutes acceptance of the following terms: The ExxonMobil Cash Card is redeemable for authorized products and services only at Exxon and Mobil facilities. This card is not redeemable for cash or credit, except where required by law. This cash card is not a credit card, debit card, asset account or deposit account. To report a lost, stolen or damaged card, call 1-800-919-8646. Remaining value may be replaced on a lost, stolen or damaged card only if the account number and remaining value on the card can be verified.—This card is issued and administered by SVM, LP. Cards sold for promotional purposes may contain an expiration date, if allowed by law. This date would be shown on the front of the card. If no date is shown, then the card will not expire, nor will it contain maintenance fees for non-use. Cards may be deactivated for administrative or legal purposes; however, SVM or its agents will replace or reimburse full value of the deactivated amount. Please treat this card as you would cash.” From the pricing from 3 to 10 percent above the cash value—one sees that the insurance premium is included in the price of the card.

Another payment instrument is the Speedpass, which is a “contactless” payment system that provides members with a quick and easy way to pay for purchases at participating Exxon and Mobil stations nation-wide. Speedpass is easier and more secure than using a credit card. (https://www.speedpass.com/forms/formHowItWorks.aspx.?pgHeader=how) “No more waiting for authorizations and signing receipts. No more searching for cash and waiting for change.

To use it, simply wave your Speedpass key tag across the area of the gasoline pump, convenience store terminal, or car wash kiosk that says “Place Speedpass Here”. Speedpass automatically—and immediately—communicates your payment preferences. It knows what credit or debit card you wish to use. Speedpass even knows whether or not you want a receipt. Speedpass is a “contactless” payment system that provides members with a quick and easy way to pay for purchases at participating Exxon and Mobil stations nation-wide. Speedpass is similar to the electronic toll technology successfully used on subway, bus, and highway systems around the world. Your Speedpass key tag has a built-in chip and radio frequency antenna that allows it to communicate with Speedpass readers at gasoline pumps, convenience store terminals, and car wash kiosks at Exxon and Mobil locations.”

The Speedpass site continues “A quick wave of your Speedpass key tag in front of the reader initiates the automatic transmission of a unique identification and security code to the Speedpass payment system so your account can be located. Your payment is instantly processed using the credit/debit card that is linked to your Speedpass. If the transaction is approved, you will receive a payment confirmation and you can be quickly on your way. Speedpass is a “contactless” payment system that provides members with a quick and easy way to pay for purchases at participating Exxon and Mobil stations nation-wide. Speedpass is similar to the electronic toll technology successfully used on subway, bus, and highway systems around the world. Your Speedpass key tag has a built-in chip and radio frequency antenna that allows it to communicate with Speedpass readers at gasoline pumps, convenience store terminals, and car wash kiosks at Exxon and Mobil locations.” . . . “A quick wave of your Speedpass key tag in front of the reader initiates the automatic transmission of a unique identification and security code to the Speedpass payment system so your account can be located. Your payment is instantly processed using the credit/debit card that is linked to your Speedpass. If the transaction is approved, you will receive a payment confirmation and you can be quickly on your way.”

What we come to understand, from the discussion of cash, checks, credit cards, RFID payment instruments, and the likes, is that the retail consumer has many payment instrument options in order to accept or complete his payment obligation in a retail transaction for a fungible commodity. Of course, there are equivalent low-tech identity proofs that also can be used to facilitate a transaction; such as license plate number, personal identity numbers, telephone number, wifi, cell phone caller ID, and the likes.

For our purposes, this kind of “retail transaction” is one where the customer accepts delivery at the time of purchase according to some substantially predetermined payment schedule, such as at the moment of the transaction (e.g. for cash) or extending to during the following year (credit payments). For our purposes, a “fungible commodity” is one that is traded on a mercantile or commodities exchange. Non-limiting examples of such a commodity include crude oil, refinery products (including heating oil and gasoline), agricultural products (like corn or wheat), precious metals, and the likes.

Now, the retail consumer, in the course of a retail transaction for an ordinary retail quantity of a fungible commodity, would like to use a convenient payment instrument and simultaneously would like to have some of the benefits of risk mitigation through some linkage to commodity futures and/or to barter; and any taxable advantage would also be welcome! On the other hand, most retail consumers would like to be the masters of their own economic instruments without having to join their respective fortunes to that of other members of a cooperative or substantially anonymous multi-party joint venture. Simply stated, there is always an ongoing need for the ordinary retail consumer to see some benefits that would otherwise be appropriate for him only if he were a wholesale customer. Nevertheless, the ordinary retail consumer would prefer to maintain or increase his level of convenience when executing a retail transaction for an ordinary retail quantity of a fungible commodity; such as is familiar to him from transaction instruments such as cash, checks, credit cards, and the likes.

### BRIEF SUMMARY OF THE INVENTION

The aforesaid longstanding needs are significantly addressed by embodiments of the present invention, which specifically relates to A Transaction Payment Instrument, uses thereof, and the likes. The instant method, apparatus, and protocol of the present invention are especially useful in creating simplified retail quantity purchase transaction interactions wherein the consumer may benefit from longer term price stability for the commodities portions of those transactions and/or where the merchant may benefit from some tax accounting advantage for these same transactions.

Turning to FIG. 1, this instant invention relates to embodiments of business methods, computer systems, and consumer contracting articles and appurtenances used for conducting a transaction with a transaction payment instrument, which is used for purchasing a retail quantity of a fungible commodity; the instrument <100> comprising (I) a prepaid commodity portion <110> (representing a commodity units credit account) and (II) a promissory cash-equivalent portion <120>. Preferably, these commodity units are backed by futures and/or options for the fungible commodity. The promissory cash equivalent portion is cash, check, credit card, cash card, prepaid commodity unit card, RFID proof of identity for conducting a commercial transaction, biometric recognition for use in conducting the transaction, or the likes. A transaction between a customer and a retailer includes (A) the customer causing commodity credits to be transferred to the retailer wherein this transfer represents the customer bartering a substantially identical quantity and quality of a commodity with the retailer in exchange for that quantity and quality of that commodity; and secondly includes the customer paying the retailer for all peripheral charges associated with the physical delivery of the physical commodity—and these charges may include refining, processing, distribution, marketing, tax, etc.

Before we turn to elaborate technical variations and combinations of these embodiments, lets consider a simple example.

Mr. Joe goes into a jewelry store to buy a gift for Mrs. Joe. Mr. Joe knows that Gold is peculiarly under valued these days, so he is sure that buying a gold item is a good investment too; however, Mr. Joe just can't decide which item to buy. The solution is for Mr. Joe to lock in the price for the retail quantity of gold that is equivalent (by weight) to the gift that he wants to buy. Since the cost of workmanship and merchandising are reasonably stable for equal quality items in the same jewelry store or chain of jewelry stores, the cost of the golden gift item should remain about constant, after Mr. Joe has locked in the purchase of a suitable amount of Gold.

After looking at lots of items, Mr. Joe decides that items of about 10 grams weight of gold are appropriate for his gift to Mrs. Joe. So Mr. Joe arranges to buy 10 grams weight of Gold on the commodities market via an embodiment of the instant invention. Now, it no longer matters how long it takes for Mr. & Mrs. Joe to decide on a gift item, they will only have to pay for the costs of workmanship, merchandising, taxes, etc.—but not for the Gold per se. This is because the 10 grams weight of Gold has essentially already been purchased by them. On the other hand, if Mr. Joe decides that he would rather buy Mrs. Joe a Platinum item, then he can sell his 10 grams weight of Gold (commodity market rights) and buy some amount of commodity market rights for Platinum.

What is marvelous about embodiments of the instant invention is that, using it, Mr Joe can now hedge his purchase costs by smartly participating in the commodities market—even though the quantities of his participation are far below the quantities of ordinal commercial transactions in these commodity markets. Another wonderful aspect of the instant invention is that there are lots of people who study the price trends of the commodities markets but are insufficiently wealthy to participate in actual commodities market transactions. According to various embodiments of the instant invention, speculating in the commodities market now becomes an accessible investment activity for the ordinary Mr. Joe.

Note that, in the context of the instant invention, an instrument is at least one physical or logical article which enables the facilitation of a financial transaction between two parties, such as a customer with a retailer, or a client with a broker, or a broker with a commodities exchange, or a retailer with his supplier, or the likes. Hence, an instrument may be and/or may include an article of hardware and/or of software, analog appurtenances (e.g. credit card, RFID tag, coupon, business forms, etc.), enabling software, or even protocols which allow for the accomplishment and/or validation of the instant transaction payment instrument clearance, or the likes.

Furthermore, in the context of the instant invention, fungible commodities need not be strictly identical; rather, there should be a simple metric of equivalence which allows for their essential substitution—each for the other. For example, in the natural gas industry, fungible substitution relates to BTU value—which may vary—making simple substitution by deliverable volume less equitable. By way of example, in the dairy industry, fungible substitution may relate to net fat content (butter) and/or net protein and/or to dehydrated weight and/or to net liquid volume times specific gravity—all rather than relating simply to net liquid volume. Likewise, for gasoline, octane ratings vary.

Recall, today, in ordinary commerce, a retail customer will pay his bill in cash, by check or using a credit card; the check is an order to the customer's bank to pay cash to the seller, and the credit card is an instruction to order the customer's bank to pay cash to the seller. Accordingly, for practical purposes in ordinary retail commerce, checks and credit cards can be substituted for cash. There are other cash substitutes too, from plain paper coupons to sophisticated biometric identification systems, RFID tags, and the likes. Collectively, retail commerce substantially operates on cash or cash equivalents. There is a significant exception to this cash-type economy view, and that is barter; where articles of equivalent value (in the eyes of the transaction participants and the tax authorities) are swapped.

On the other hand, today, in ordinary commerce, a large wholesale customer will generally manage the risks of fluctuating raw material prices by managing short and long term contracts on a government regulated commodities exchange. The retail customer is generally precluded from the risk mitigation benefits of the commodities exchange transactions, because these transactions deal in quantities which are to large for the retail customer to invest in; also the ordinary retail customer can not invest his time in understanding the many complexities of commodity market trading.

Now, turning again to the instant invention, essentially (as a non-limiting example) a commodities broker is providing a credit card type financial instrument (CCTFI) to a large number of retail customers. The type of transaction that this CCTFI will participate in depends on the agreement between the commodities broker and the CCTFI holder. The agreement may be static or may have dynamic components.

Let's start with (1) the simplest case agreement. The CCTFI holder has a standing instruction with his broker to pass all CCTFI transactions directly through to the bank—which means that the CCTFI is exactly another credit card.

According to (2) a slightly more developed instruction, the broker is instructed to manage the buys and sells of the customers commodity market position according to rules that the customer changes from time to time—however part of those rules call for the broker to sell commodities market items from the customer's account in order to cover the expenses incurred by the customer to buy goods or services using his CCTFI; which makes the CCTFI on the merchant side look like an ordinary credit card and on the broker side look like a sell instruction. However, since the retail purchase amount may be substantially less than a cost-effective single service fees inclusive transaction sale on the commodities market, the commodities broker may actually be a commodities fund (cooperative) manager who bundles retail transactions from a plurality of CCTFI holders in order to generate a single commodity sell instruction—wherein the commodities investment strategy may come from a merging of instructions of the various CCTFI holders or may be according to the expertise of the broker. At this stage the broker may deal in commodities, stock & bonds, real estate, derivatives, or any other items that are manageable to back to the CCTFIs.

Turning (3) to a still more developed CCTFI policy, the broker is focused on a specific class of commodities, such as petroleum products. Accordingly, when the CCTFI is used to buy a petroleum product (e.g. retail gasoline or home heating oil), then the broker will cover the expense incurred for the retail purchase of the petroleum product with the sale of some amount of like product (from the CCTFI holder's account) on the commodity exchange—likewise according to the aforesaid possible instructions and management arrangements. Now, in the context of this non-limiting example petroleum products transaction, the broker may bundle the retail quantities of many CCTFI purchases and swap the commodities market ownership of the petroleum product with the agent of the retail seller who sold (delivered) those retail quantities to the CCTFI customers. This is essentially what the large energy companies do with each other, when say an east coast refinery (managing to take crude oil delivery on the west coast) cleverly swaps delivery with a west coast refinery (respectively managing to take crude oil delivery on the east coast)—both of them benefiting from the saving from now nonexistent coast to coast transport of the respective crude oil shipments. Of course the energy companies swapping (bartering) of crude oil also must take into account disparities between various peripheral charges on the east and west coasts—such as tanker docking fees, unloading charges, local taxes, etc. Likewise, in the case of our CCTFI transactions, even if the broker is covering the retail petroleum product purchase with a bundled sale or swap via the commodities market, the broker must also account for portions of the respective retail purchase (charges) which are incurred in the transportation, storage, handling, etc. of the physical petroleum product. In order to pay the retailer for these charges, the broker reverts to aforementioned financial models for using the CCTFI, such as instructing the bank, selling of stocks, bonds, etc.

Certainly, (4) there may be instances where the retailer does not want to swap, so the CCTFI reverts to being a commodity, stock, bond, etc backed method of payment guarantee for the payment of an obligation between the customer and the retailer. Accordingly, there are instant embodiments which are new commercial instruments and there are other instant embodiments which include instantiations of known commercial transactions. Apparently not every transaction accomplished using the instant invention (transaction payment instrument) is necessarily a new type of transaction; and careful analysis of the chain of events for the actual transaction processing may probably be needed in many circumstances to determine if the instrument in use is new or otherwise. Please note that this circumstantial reversion of the instant invention instrument to heretofore known commercial uses does not restrict the instant invention any more than a hypothetical inventor of a screwdriver would be restricting his invention by observing that sometimes a workman will invert the screwdriver and use the handle as a heretofore-in-public-domain mallet.

As mentioned elsewhere, CCTFI and similar embodiments for the instant invention are not directly linked to the respective market commodity prices (and futures) rising, fluctuating, or falling. However, consumer and/or merchant participation in the actualization of transactions (using the transaction payment instrument of the present invention) will certainly vary according to these and still other macroeconomic factors.

Turning now to FIG. 2, we see an overview of a typical use of a Transaction Payment Instrument according to the present invention, wherein a customer <210> transacts with a retailer <220> thereby taking delivery of goods <250> by virtue of the customer presenting and the retailer accepting the customer's CCTFI <260>. This local customer with retailer activity causes a series of methodological protocol steps to be enabled whereby the customer's broker <230> transfers goods equivalent commodity credits <270> and cash equivalent (to the non commodity value portion of the goods) <280> to the retailer's account <240>. As is described herein, the actual transferred items <270 and 280> are according to the combined (made to be mutually agreeable) instructions of the customer to his broker and the retailer to his account.

Summarizing, an embodiment of the instant invention relates to an unusual and unlikely mercantile scenario. A customer has a quantity X of grade A fungible commodity B and the customer has some cash or the ability to pay cash (e.g. checks, credit card, etc.). Now the customer approaches a retailer who by incredible coincidence has a quantity X of grade A fungible commodity B for sale. OK, the customer enters into a transaction with the retailer. According to the terms of this transaction—firstly the customer will swap his quantity X of grade A fungible commodity B in exchange for the retailer's quantity X of grade A fungible commodity B—and secondly the customer will pay the retailer substantially all of the parts of the retail price for the actual delivery of quantity X of grade A fungible commodity B from the retailer to the customer; and these parts include such things as distribution costs, marketing costs, refinery costs, profit, tax, and the likes. In short, the customer will essentially pay for quantity X of grade A fungible commodity B—which is the ordinary retail price “less” (minus) the actual cost of a quantity X of grade A fung ible commodity B per se—since the customer is swapping this with the retailer [i.e. not including the current retail value of the quantity of fungible commodity per se].

According to embodiments of the present invention—for just such a swap plus cash—the customer will generally see a tangible benefit—and the retailer may see some benefit too. OK—let's consider how this transaction really works. The customer will buy units of commodity credits via a broker or system management organization—and will substantially benefit from the wholesale commodity price for this commodity on the date that the units were purchased. If the price for this commodity goes up, then the customer will actually be getting the benefit of the lower commodity price when he takes delivery from the retailer. The customer gives the retailer the commodity credits and pays the retailer for all of the other aspects for the transaction. Thus the customer actually pays less than he would have paid—if he were to pay for the commodity at today's higher price plus the retailers other costs and charges. The retailer (in some jurisdictions) may actually be able to charge lower costs and charges—if this transaction is now considered to be for services only—since the swap of identical goods is not normally considered to be a commercial transaction. There may be lower taxes on this kind of swap plus costs transaction too. Alternatively, if the commodity price is going down, then the customers will tend to use up his commodity credits—according to his capacity to take delivery. Simultaneously, we expect to see a drop in customers buying into new commodity credits.

In a practical sense, the customer may give the retailer cards or coupons (physical or encrypted electronic) as a way of transferring the commodity credits—and the customer may pay the remainder as he would in any commercial transaction (by cash or credit card, etc.). Alternatively, the customer may have a “commodity-&-credit card” which connects the customer and the retailer and the card to a single agency which transfers commodity units from the customer's account to the retailer's account—and also transfer's cash from the customer's account to the retailer's account—as appropriate.

Because, both the customer and the retailer would like to improve their respective profitability in the same transaction—each may elect automatically (by prearranged manual authorization or by parametric computer program decision) to pay for and/or accept payment for the whole transaction in cash, or to divide the transaction into commodity swap plus cash. The reality of the transaction may be transparent to the parties for the actual transaction—which makes things much easier—since these parties will probably not know nor need to know (at the time of the transaction) which combination of buyer and seller instructions are operative. Furthermore, in times of sharply rising commodity prices and/or commodity rationing—there is an incentive for the retailer to accept commodity credits—since this may help him to be re-supplied by his distributor, etc.

Of course, there are lots of other less facile combinations for actualizing a swap plus costs transaction. One might use a commodity account card to arrange the swap and a credit card to pay for the costs, etc.

Now returning to other enabling embodiments of the instant invention, a principle embodiment of the instant invention relates to a transaction payment instrument, for use in a transaction for purchasing a retail quantity of a fungible commodity, and the instrument is comprising (I) a prepaid commodity portion (representing an account having therein credits for commodity units) and (II) a promissory cash-equivalent portion. According to one aspect of this principle embodiment, the instrument is embodied as a convenient appurtenance, such as a credit card or an RFID tag or a biometric recognition, wherein a consumer executes a purchase of a retail quantity of a fungible commodity using the appurtenance. Alternatively, the user may have a commodity card (like a prepaid telephone calling card) having securely encrypted thereon at least one commodity credit—and the retail transaction will call on the merchant to accept the credit in lieu of payment for the commodity portion and to accept cash (or a cash equivalent) for the other portions of the transaction—e.g. marketing, tax, distribution, processing, etc. of the commodity.

Now, according to a more central embodiment of the instant invention, the instrument is a logical set of computer executable instructions that is located at an electronic commerce juncture in a funds transfer accounting system. In this instance, the instrument is enabled as a protocol at that juncture that recognizes the consumer via his appurtenance or via a personal password or via any other legally recognized identification that can be validated in a commercial dispute resolution proceeding, and the instrument at that juncture is active in facilitating a division of a customer with merchant retail transaction for the acceptance of delivery (from the merchant to the customer) of a fungible commodity—wherein—if the merchant accepts such a division and if the consumer elects such a division, then the commodity is bartered for a consumer prepaid commodity credit (the ownership is transferred to an account of the merchant) and the other charges are paid for substantially as in ordinary consumer-with-merchant transactions. Preferably, the commodity credit is backed by a commodity futures or options purchase—as is herein described in greater detail. There are also clear economic advantages to the provider of this instant invention instrument system service—because there is increasing cash reserve latency in the providers account during commodity price-increasing periods—which in the case of crude oil related products seems to be for the foreseeable future.

Thus, the present invention essentially also relates to a business method that bring with it certain novel uses for known financial instruments (or combinations thereof); and these in turn then are the driving parameters of a new class of transaction—which operates within the confines of ordinary electronic funds and/or electronic credit and/or electronic commodity futures transfer systems. Now there are numerous independent objects of the present invention, such as providing: the benefits of wholesale commodity trading to retailers and/or customers, and/or the benefits of tax differential advantages associated with swapping of substantially identical fungible commodities (like 10 gallons of 95 octane gasoline for 10 gallons of 95 octane gasoline) wherein the normal taxable consequences of barter seem to require a threshold of trading something for something-else. Likewise, there may be peripheral benefits to the merchant in his transferring his accumulated commodity credits to his supplier (as barter for the commodity per se) who in turn optionally transfers the accumulated credits to his distributor (as barter for the commodity per se), etc.; migrating upward through the petroleum market value chain converges to resemble the PSBOG described above—albeit generally for less than PSBOG quantities.

By way of a non-limiting example, today (according to the US Department of Energy) the US retail price of gasoline (or diesel fuel) at the pump is 19-21% tax, 4-5% distribution and marketing, 22% refining costs, and 52-55% crude oil commodity price. So for the purposes of the instant invention, the commodity credits can be used in exchange for paying for the 52-55% crude oil commodity price—while the cash equivalent can be used to pay for the remainder; keeping in mind that there may be a differential in the tax component—even at the retail level.

Turning to FIG. 3, the instant invention also relates to embodiments of a transaction payment method, for use in an electronic communications facilitated transaction for purchasing a retail quantity of a fungible commodity, and the method includes: (A) a secure central transaction processor <310> electronically accepting <320> a transaction request including (I) customer account authorization data, (II) retailer account authorization data, (III) first data describing a quantity of fungible commodity being delivered by a retailer associated with the retail account to a customer associated with the customer account, and (IV) second data quantifying retail services charges associated with a sale of the quantity of fungible commodity [not including the current retail value of the quantity of fungible commodity per se]; (B) the processor validating <330> (I) the customer account authorization data and (II) the retailer account authorization data; (C) the processor electronically transferring <340> the first data quantity of commodity units from the customer account to the retailer account; and (D) the processor electronically transferring <350> the second data quantity of cash from the customer account to the retailer account. Variants of this method include relating to ongoing instructions from the customer and/or from the retailer—such that in parts (C) and/or (D)—(i) the commodity unit may be sold to pay for the commodity quantity, (ii) a different commodity unit may be sold to pay for the commodity quantity, (iii) a different commodity unit may be transferred to “pay” for the commodity quantity, (iv) cash or more of the commodity units or different commodity units may be used to “pay” for the second data quantity, or the likes.

Preferably, according to embodiments of the aforesaid method of the instant invention, accepting a transaction request includes first specifying the commodity units to include at least one metric that is selected from a list: quantity, volume, weight, energy content, nutritional content, or the likes; and/or second specifying the commodity to be a substantially fungible item that is selected from the list: crude oil, heating oil, aviation fuel, diesel engine fuel, internal combustion engine fuel, hybrid engine fuel, natural gas, bio-fuel, methane, propane, acetylene, a liquefied gas, a petroleum refinery product, a precious metal, a strategic metal, bottled water, a commercially traded commodity having an ongoing short term or medium term or long term futures price on a government regulated commodities exchange, or the likes.

The instant invention furthermore relates to embodiments of a transaction payment instrument, for use in an electronic communications facilitated transaction for purchasing a retail quantity of a fungible commodity, and the instrument is comprising a memory media (e.g. printed, analog, digital, electronic, etc.) having securely encoded therein (I) a prepaid commodity portion representing an account having therein credits for commodity units and (II) a promissory cash-equivalent portion.

According to a first variation embodiment of the instrument, the memory media further includes at least one item selected from the list: general customer account authorization data, customer account authorization data specific to an account holding credits for a predetermined fungible commodity; and customer account authorization data specific to a payment account for making payment of a promissory cash-equivalent demand.

According to a second variation embodiment of the instrument, the memory media is selected from the list: RFID, credit card, secure data storage card, and biometric measurement device.

According to a third variation embodiment of the instrument, the promissory cash-equivalent portion is tied to a monetary instrument having an ongoing short term or medium term or long term futures price and having an ongoing indeterminate linkage with a national or international currency.

Now turning to FIG. 4, the instant invention in addition relates to embodiments of a method <400> for exchanging a commodity for a transaction payment instrument actuation including the steps of: (I) a buyer presenting <410> a transaction payment instrument comprising (A) a prepaid commodity portion representing an account having therein credits for commodity units and (B) a promissory cash-equivalent portion; (II) a seller accepting <420> said instrument; (III) the buyer requesting <430> a quantity of the commodity; (IV) the seller deducting <440> from the instrument (A) credits for commodity units corresponding to the quantity requested, and (B) a cash-equivalent amount corresponding to bundled costs associated with the quantity of requested commodity wherein the bundled costs are selected from the list: profit, marketing charges, delivery charges, service charges, storage charges, tax, processing charges, and calculated differential between price for the prepaid commodity portion unit and price for the requested commodity; and (V) the seller delivering <450> the requested quantity of commodity to the buyer.

Turning now to Advantages, Objects and Benefits of the Instant Invention, we would like to focus on some Ergonomic Issues: There are two substantial variation embodiments of the instant invention—according to a consumer vantage. According to one of these substantial embodiments, a consumer will decide at the time of a purchase of a retail quantity of a fungible commodity (such as gasoline or heating oil) if he wants to pay for the commodity portion with his pre-purchased (futures backed) commodity credits, and the other charges with cash or a cash equivalent (e.g. check, credit card, etc.)—or if he would rather pay for the entire transaction (commodity plus other charges) by cash or cash equivalent (as is the current prevailing method for such purchase transactions in the retail marketplace). According to the other of these substantial embodiments, the consumer will establish parameters for an automatic computer program to manage the decisions regarding either purchase by commodity credits plus cash equivalent or purchase by cash equivalent alone. According to a prearranged agreement between the consumer and his management program, an analysis of the commodity market conditions (long and/or short term) will be performed (either in real time or according to a predetermined schedule) and according to the results of this analysis, the program will elect for the consumer if the transaction is for purchase by commodity credits plus cash equivalent or purchase by cash equivalent alone; leaving the real-time consideration transparent to the consumer. Of course, even if the consumer (actively in real time or via the wisdom of his automatic rule based instructions) elects to pay for the retail quantity commodity purchase in cash equivalent, the CCTFI broker may be enabled to sell assets (e.g. stocks, bonds, etc.) in order to accomplish the authorized cash payment.

Turning to the other side of the transaction, from the vantage of the retail merchant, likewise the merchant may either decide in real time or according to a prearranged parametric market analysis program—if the merchant is only accepting cash equivalent for sales of retail quantities of a fungible commodity—or if the merchant is accepting payment for commodity in commodity credits and payment for other charges in cash equivalent. Presuming that embodiments of the instant invention become situated as standard in the marketplace, the merchant may also have automatic rule based instructions for accepting other assets from the customer's portfolio, instead of the commodity equivalent swap.

Turning now to Advantages, Objects And Benefits of the Instant Invention, we would like to focus on some Economic Issues: The economic benefit to the consumer of these substantial embodiments rests in his ability to somewhat separate himself from many of the short term retail price market fluctuations—thereby allowing himself a better management of his budget for the purchase of fungible commodities. For the merchant (not a commercial buyer but the seller of the commodity), the economic benefits of these substantial embodiments rests in his ability to somewhat separate himself from some of the taxable consequences of the commodity for commodity credits portion of the transaction (the swap)—since taxable barter is the trading of “apples for oranges” and not the exchange of identical item s for each other. It is beyond the scope of the instant invention to consider the many regulatory and/or case law combinations which will ultimately determine how various tax authorities will view a use of the instant instrument appurtenance in one jurisdiction (where delivery of the commodity occurs from a retailer to a customer), while the logical ownership barter of substantial equivalents occurs closer to the jurisdiction of the broker and/or of the commodities exchange, etc. Neither can we address the taxable consequences of bundling retail commodity market participants, risk mitigation mechanism applied to their respective commodity portfolio ownership portions, etc.

Turning now to Advantages, Objects And Benefits of the Instant Invention, we would like to focus on some Technical Issues: The basics of enabling many embodiments of the instant invention focus on the existence of a commodities credit management program where commodities credits are purchased by consumers and respectively deposited into consumer accounts for use in commodity credit for commodity barter transactions (accompanied by a cash equivalent for other services transaction portion) and backing the value of the commodity credits (by the management program) is with the buying and selling of commodity futures, options, and possibly some mix of speculative financial instruments. Please note that part of the merchants' potential taxable consequence savings is taken by the taxable consequences of the consumer program commodities market futures transactions.

To a different extent, another technical aspect of enabling the embodiments of the instant invention focuses on the establishment of an automatic instrument for use in the commodity for commodity credits “barter” transaction portions. This instrument may be like a credit card or like a calling card or have a biometric verification component, CCTFI, or the likes.

Turning now to aspects of the instant invention that are related to the economic viability of management of accounts for the commodity units and credits (since the management of cash equivalent portions is well known in the credit card and check processing industries), what is important to appreciate here is that there will tend to be fluctuations in the consumers investing in the buying of commodity units—even as these units are offered in retail quantities at substantially wholesale futures and options commodities market prices. Consumer purchase of units will tend to go up when there is an expectation that the commodity prices are going up. Similarly, consumer use of the commodity credits as part of a purchase transaction will tend to increase when the consumer believes that the commodity prices are stable or are going to fall. Even though this leaves some disparity between the consumer desire to use the credits and the retailer desire not to accept the credits in times of falling commodity prices—generally the consumer will invest in commodity credits as a way to stabilize his long term budget for fungible commodity items that he regularly uses—like gasoline for his car or heating oil for his house; likewise in B2B business activity; gold for his jewelry store; or the likes.

One can describe a model for this kind of market event as having an indeterminate cash flow coming into a commodity credit managers “fund” where the fund must hold & manage the cash “value” according to a predetermined commodity price (at the time that the commodity credits were purchased) and for respective indeterminate events (at indeterminate dates) either deliver the commodity—or to pay for same. More sophisticated funds will see cash in from customers buying a variety of commodity credits, the holding and managing of the cash “value” according to the predetermined commodity mix; and at an indeterminate date—either deliver a commodity of the commodity of the mix—or pay for same.

Lets begin to consider “Value Added” which allows consumers to participate in retail quantities of commodity at wholesale price structure—because commodity speculation has minimum quantity (e.g. 1000 Barrels); and the “Capital Asset Pricing Model” which relates to how to diversify risk—(vested interest motivation—since consumer will need to use commodity)—and hedge commodity risk for consumers and small businesses.

Modern finance rationalizes the pricing discrepancy between futures and spot prices using (i) Capital Asset Pricing Model (CAPM)/Consumption Capital Asset Pricing Model (C-CAPM) (Kolb, 1996; Breeden, 1980; and Jagannathan, 1985); or (ii) Hedging-Pressure Hypothesis (Hirshleifer, 1988); or (iii) General Equilibrium Theory (Anderson and Danthine, 1983; Britto, 1984; Young and Boyle, 1989; and Francis, 2000).

The Capital Asset Pricing Model (CAPM) was originally developed in 1952 by Harry Markowitz and fine-tuned over a decade later by others, including William Sharpe. The capital asset pricing model (CAPM) describes the relationship between risk and expected return, and it serves as a model for the pricing of risky securities. CAPM says that the expected return of a security or a portfolio equals the rate on a risk-free security plus a risk premium. If this expected return does not meet or beat our required return, the investment should not be undertaken. Thus, the capital asset pricing model (CAPM) is an equilibrium model which describes the pricing of assets, as well as derivatives. The model concludes that the expected return of an asset (or derivative) equals the riskless return plus a measure of the assets non-diversiable risk (“beta”) times the market-wide risk premium (excess expected return of the market portfolio over the riskless return). The key insight of the Capital Asset Pricing Model is that higher expected returns go with the greater risk of doing badly in bad times. Beta is a measure of that. Securities or asset classes with high betas tend to do worse in bad times than those with low betas.

With the price of Gasoline rising and very volatile, a system is needed for consumers to be easily able to lock in large block purchases of gas. In order to do this they will purchase a block of gas i.e. $2000 worth on an auction website called the GasXchange (hereinafter synonymous with a non limiting example embodiment of the instant invention as applied to the fungible commodity of gasoline). Since the $2000 may be substantially less than a cost efficient minimal unit of gasoline commodity on a government regulated commodities exchange, the $2000 of GasXchange commodity is only respectively a front end portion of a bundled commodities futures purchase by the GasXchange broker to the government regulated commodities exchange; while for the small commercial customer of $2000 of GasXchange commodity, the GasXchange front end may prove convenient for peripheral reasons. As mentioned before, during periods of fluctuating or dropping commodities prices, one expects that the consumer will stop investing in commodities credits and simultaneously use up his purchased credits as quickly as his ability to take delivery allows; the reverse being the expected practice during a rising market period.

For example, the price paid will be the average price in that particular state on that day for regular unleaded gasoline; or if the consumer wishes to purchase super, then the price paid will be for the average price of super unleaded, etc. Ideally, GasXchange will make a deal with a major Credit card company (preferably American Express) whereby the consumer will use his American Express card to purchase that $2,000 worth of gas. Lets say unleaded gas is at $2.00 a gallon that day then American Express (or “AE”) will record on his card the charge of $2000 but will also place in their system or records that he paid $2 a gallon. AE will then buy futures on gas to cover this 1000 gallons. So let's say the price goes up to $2.50 per gallon then the consumer will go and buy gas at the station and pay the station $2.50 per gallon and then AE will sell the futures and pocket the 50 cent profit and use that profit to rebate the consumer the extra 50 cents. Hence the real price paid by the consumer was only $2.00.

Furthermore, there are other perhaps less automated aspects of commerce using the transaction payment instruments of the instant invention, such as a GasXchange internet site functioning as an auction site; letting (for example) a consumer (who bought $2000 worth of gas at $2 per gallon) after the price per gallon leaps to $2.50 to sell (e.g. by auction) to another consumer the whole 1000 gallons and pocket the $500. Of course then that first consumer would pay the full $2.50 at the gas station and not receive any rebates in this case. So then the site would function as an Exchange site to sell Gas (or other commodities) back and forth between consumers. Of course, one of the things that is peculiar about this type of site is that the quantities being auctioned, sold, or traded are respectively less than what is cost effective for the government regulated commodity exchanges for the same commodity.

Finally, by way of a modest analog-type example, consumers would be purchasing and selling GasXchange issued cards from each other for assorted goods or services, not necessarily in exchange for actual gallons of gasoline—meaning that acceptance of the GasXchange card as a representation of the value of gas credits will probably cause the card (inclusive of its credits) to have a value per se. We might consider having a special electronic gas card for each user (or simply printing secure fixed commodity denomination coupons) of an internet site whereby that user could buy gallons and those gallons would be recorded on his electronic card and when he wishes to use them he could transfer them using the GasXchange site to his AE card. If he wants to sell them he would never transfer them to his AE card; since they would just stay on his electronic card and he could buy or sell them to other consumers on the GasXchange website. The instant appurtenance embodiment of a gas “Lard” facilitates that consumers are not really auctioning off gas but rather gas “Lards”; likewise a transaction having tax consequences beyond the scope of the instant invention disclosure.

Notices

Numbers, alphabetic characters, and roman symbols are designated herein are for convenience of explanations only, and should by no means be regarded as imposing particular order on any method steps. Likewise, the present invention is herein described with a certain degree of particularity, however those versed in the art will readily appreciate that various modifications and alterations may be carried out without departing from either the spirit or scope; as hereinafter claimed.

In describing the present invention, explanations are presented in light of currently accepted Scientific, Technological or Mercantile theories and models. Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

### BRIEF DESCRIPTION OF THE DRAWINGS

In order to understand the invention and to see how it may be carried out in practice, embodiments including the preferred embodiment will now be described, by way of non-limiting example only, with reference to the accompanying drawings. Furthermore, a more complete understanding of the present invention and the advantages thereof may be acquired by referring to the following description in consideration of the accompanying drawings, in which like reference numbers indicate like features and wherein:

FIG. 1 illustrates a schematic view of a Transaction Payment Instrument;

FIG. 2 illustrates a schematic view of a TPI transaction event—from the vantage of the participants;

FIG. 3 illustrates a schematic view of another TPI transaction event—from the vantage of an electronic commerce processor; and

FIG. 4 illustrates a schematic view of a TPI method—from an objective vantage.

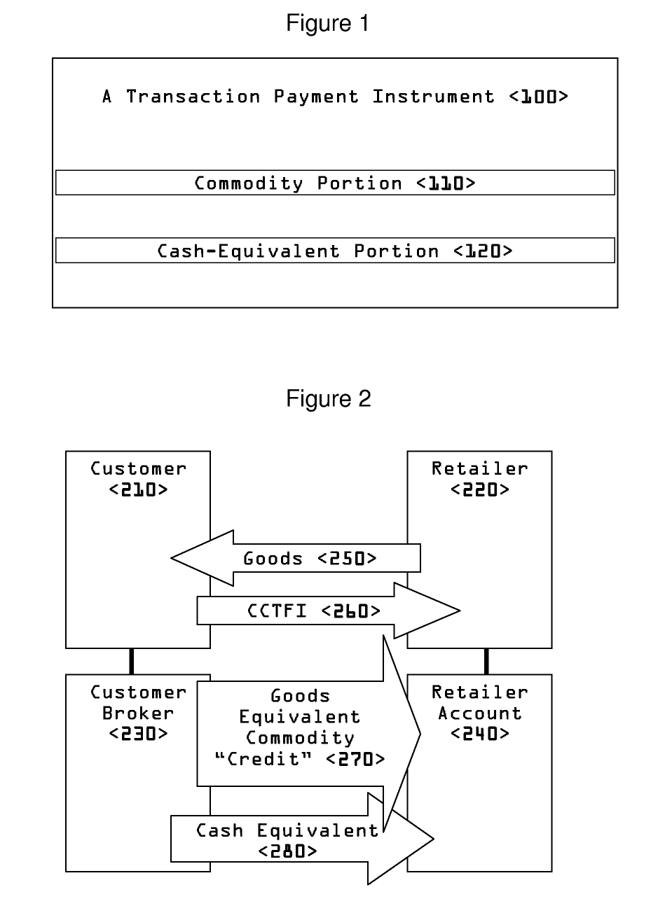

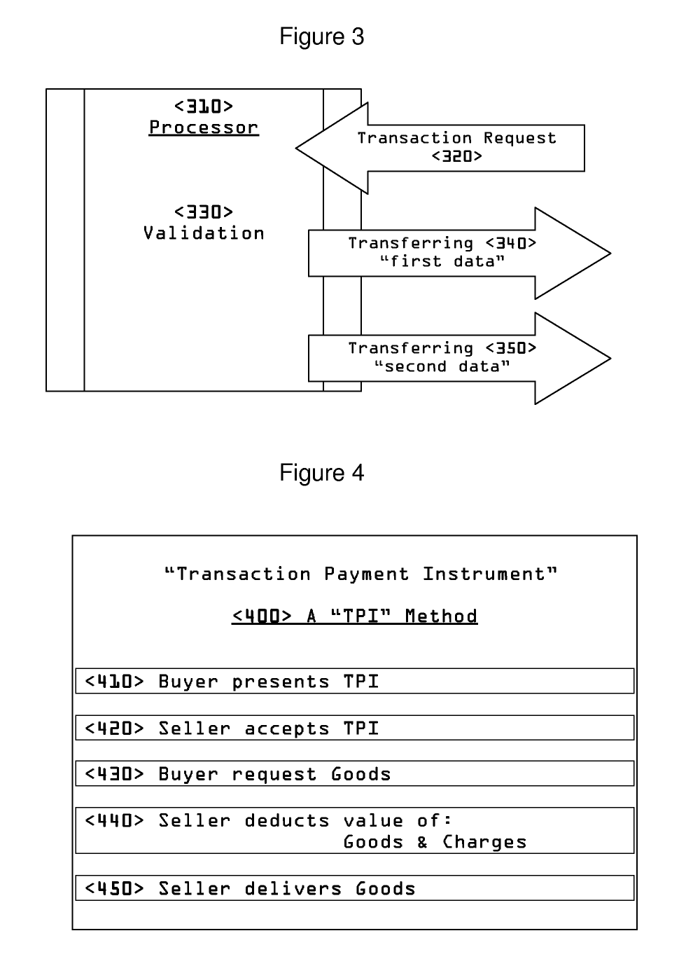

### DETAILED DESCRIPTION OF THE INVENTION

Embodiments and aspects of the invention may be embodied as various forms of creating and/or using retail quantities of commodity credits; which may be anonymous (like a telephone calling card), personalized (like a credit card), and/or optimized (like a protocol of rule based instructions to a broker/manager/agent for the buying and/or selling of commodities, futures, options, and likes on a government regulated exchange) particularly wherein the broker transactions are essentially bundled smaller instructions for various individuals whose transactions individually would be of insufficient size (or value) to justify a buy or sell order on a government regulated exchange.

An instant invention embodiment of a transaction payment instrument (be it CCTFI, coupon or the likes) and related methods and protocols for their actualization may be beneficial to the consumer—since he gets the earlier futures price; beneficial to an employment relationship—since both benefit from a contract stable term (for the instance where the employer undertakes to supply his employees with gas or heating oil or some other fungible commodity); beneficial to the supply chain members—since barter transactions are—loans and repayment is of substantially identical merchandise; and beneficial to the financial institution—since it gets the benefit of a large cash surplus—made from the credit purchases—delayed to the delivery dates.

Standard embodiments of the instant invention transaction payment instrument are used in purchasing a retail quantity of a fungible commodity. The instrument is comprising (I) a prepaid commodity portion and (II) a promissory cash-equivalent portion. Preferably, the prepaid commodities portion is backed by futures and/or options for the fungible commodity. The promissory cash-equivalent portion is cash, check, credit card, cash card, prepaid commodity unit card, proof of identity for conducting a commercial transaction, or the likes. The transaction between the customer and the retailer typically includes the customer (A) causing commodity credits to be transferred to the retailer wherein this transfer represents the customer bartering a substantially identical quantity and quality of a commodity with the retailer in exchange for that quantity and quality of that commodity; and (B) paying the retailer for all peripheral charges associated with the physical delivery of the physical commodity—and these charges may include refining, processing, distribution, marketing, tax, etc.

Now, as you have come to appreciate, even if there is a clear benefit to the instant invention for the consumer and/or for the merchant and/or for those above him in the value chain for the fungible commodity of a transaction between the consumer and the merchant, another aspect that is required is to guarantee the robust value of the commodity credits. Since these credits are substantially in retail transaction size portions, we will now discuss various non limiting example of how the provider of the services, methods, and systems of the instant invention instrument may manage the credit “pool” for a aggregated collection of customers—even in the event that respective customer and/or merchants are proactively or automatically modifying their respective policies and instructions with respect to the management and use of their commodity credits.

Provision Of Commodity Insurance In Today's Marketplace: It is a common situation for a manager to be in a situation where he must be ready at any given moment to deliver a specified quantity of a particular commodity, or else the money value of that commodity. Today's marketplace provides a wide variety of products and financial instruments that can help ensure such readiness.

Why Such Insurance Might Be In Demand: Before we discuss the ways in which supply can be guaranteed, let us examine why this guarantee might be needed. Let us take an example where the manager must be prepared to come up with 4 tons of aluminum. One possibility is just to wait around until the need arises, and then obtain the aluminum at the going rate, in the so-called “spot market” for standard commodities. The problem with this option is that commodity prices and availability fluctuate quite a bit. The possibility exists that when our manager is actually in need of the aluminum, the price will be much higher than it was when the original obligation was incurred.

Very often a small increase in price is a mere inconvenience, but a large increase spells disaster, and can even endanger a firm's ability to function. In this case, it is worthwhile to pay a small premium in advance in order to be insured against a large increase in price. This is no different than any other kind of insurance, where a person is willing to pay a small premium on an ongoing basis, in order to ensure that he doesn't get hit with a disastrous loss in the case of fire, accident, etc.

We will discuss some common situations where such “commodity insurance” could be required.

PRODUCTION: The manager uses aluminum in production of his product. He must be sure of keeping his plant running. To eliminate the risk of running out of aluminum, he has to have a plan ensuring he will always be able to obtain it. Failing to meet a customer order in a timely way can be very costly, as customers are liable to take their business elsewhere. Yet if the price of aluminum soars, the manager could face a devastating loss. It is better to reduce profits a little bit in order to guarantee future supply at a reasonable price.

COMMERCE: The manager actually deals in the commodity, and he has made a sale but not yet made delivery. Suppose he is in the aluminum business and has contracted to provide a customer with 4 tons. The customer can ask for delivery any time he wants. The manager must make sure that when the customer demands delivery, he has on hand either the commodity itself or the means to acquire it readily. Again, if the price goes up in the meantime the manager may find that all his profit is wiped our, or he may even face a loss.

FINANCIAL OBLIGATION: The manager has made a financial market contract obligating her to have the aluminum or the money ready. For example, suppose he sold a “call” on 4 tons of copper. A call is an option that entitles the buyer to demand delivery of the underlying product. An American-style option entitles him to demand delivery any time he likes until the expiration of the contract. The manager is the seller of the option, and must stand ready to meet this demand. Sanctions for failing to meet such obligations are severe, while a price rise may make it impossible to fulfill the obligation.

In all three examples above, the purpose of the transaction is to reduce risk. This is sometimes called a “hedge.” Not having the aluminum would cause a great loss—closing down production, breaching a sales contract, or reneging on a financial contract. Obtaining aluminum at a high price could also cause a major loss. The answer is to “lock in” a reasonable price.

At times, locking in a low price is desired not to reduce risk but on the contrary in order to make a bet, to profit from a price change. Here is one example:

SPECULATION: Perhaps the manager is convinced that the price of aluminum will rise. If he has guaranteed himself a certain quantity of aluminum at a given price, then he will be certain to be able to profit from a price rise.

This is the mirror image of the other cases. When the obligation to supply aluminum already exists, a rise in price represents a risk. When no current obligation exists, a rise in price represents an opportunity to sell in the future at a profit.

How then can the manager be certain to have the value of the aluminum ready when it is needed? Here are some possibilities, with their pros and cons:

Ways in which Commodity Prices can be Insured

PURCHASE: The manager can just purchase four tons of aluminum and store them. They will be on hand as inventory for the factory or for delivery; for sale or delivery to the buyer of the options; or for sale to take advantage of a price rise.

The two disadvantages of this option are credit costs and storage costs. By buying the aluminum right away, the manager will not be able to earn interest on the purchase price. Furthermore, the aluminum must be stored and this involves storage costs (warehousing). So there is an opportunity cost and an out-of-pocket cost.

The main advantage is that the manager is not dependent on anyone else. A contract to supply aluminum is very valuable, but there is always a chance, however small, that it will be breached. This is particularly likely if the contract is with one particular firm, but even if a right is obtained through an exchange, trading can be suspended in times of uncertainty or volatility. The possibility also exists that the inventory could be sold above the market price to some other customer who has an urgent need of the commodity.

The advantage of having the commodity on hand is often referred to as the “convenience yield,” and for some goods it can be quite significant.

Another advantage of physical inventory is that this “option” never expires. Inventory in the warehouse will be available whenever it is needed.

Now, if the manager knows exactly when the good will be needed, or at the least that it will not be needed before a certain date, then it may be advantageous to acquire a futures contract. The seller of such a contract guarantees delivery of the underlying commodity (in our example, aluminum) at some future date. If there is a need to ensure that the money will be ready, some low-risk financial instrument can be acquired (for example, a Treasury bond or a bank CD.) There is no cost of foregone interest and no storage cost. (A forward sale is a slightly different kind of futures contract, wherein the money is paid right away for future delivery. In this case interest is foregone, but the price is discounted to reflect this fact.)

### Taking Advantage of Price Declines

Both physical inventory and future acquisition have the advantage of guaranteeing a maximum price, but they have the corresponding disadvantage of obligating a minimum price. If the price of aluminum declines sharply before it is needed, then the manager will not be able to take advantage of the decline. This is the nature of a hedge. If the purpose of the position is speculation in anticipation of a rise in price, then ignoring price declines is prudent. But if the purpose of the hedge is insurance against price rises, then the manager may want to maintain the ability to profit from price declines.

One type of hedge that overcomes this problem is buying a call option. A call option gives the purchaser the right to purchase the underlying commodity at a given price. In the case of American options, which are most commonly traded in United States exchanges, the right persists from the day of acquiring the option until the day the option expires. While the expiration of the option seemingly creates a disadvantage, in reality the option can always be exercised (by demanding delivery) or closed (sold for money which can buy inventory) before it expiration and then the manager is no worse off than if he had acquired the commodity itself right away.

If the price of the commodity declines, the option will be worth less, since any person can buy the commodity at a lower price. But the manager will then be able to benefit from the new, low spot price; and eventually will probably use the purchased commodity credit too.

Another possibility is just to put aside enough money to provide for any anticipated price of the commodity. If the current price of aluminum is $1000/ton, then $4000 is enough to acquire four tons. If the manager sees no reasonable likelihood that the price will be above $2000/ton, then it may be prudent just to put aside $8000 of resources to be available when the aluminum is needed. Alternatively, the manager could set up an irrevocable line of credit for all or part of the amount.

If the price of aluminum goes up, the money will be available to acquire it. If the price goes down, then the manager will be able to take advantage of the decline and acquire it inexpensively.

There are also hybrid strategies. Suppose that the manager expects prices to be stable, but needs to be covered in case of a sharp rise. $2000 per ton could be put aside in cash or ready credit; a call option could be acquired at a strike price of $2000. Since such a high price is unlikely, such an option would be very inexpensive. Part of the insurance against high prices is provided by the extra cash, and part is provided by the option (which is at a high, “but of the money” strike price). If aluminum prices decline, the manager will be able to acquire it at a low price.

Another hybrid approach would be to acquire a futures contract, and simultaneously acquire a “put” option, which guarantees the manager the ability to sell the aluminum at a particular price. If the price goes up, the manager will just take delivery of the needed aluminum. If prices go down, the manager can utilize the put option to sell the metal at the same high price he paid, and then turn around and acquire the inventory he needs at the new, low price.

### Creating a Pool or Fund

Until now we have essentially been discussing scenarios for single transactions where the manager is concerned about production, commerce or financial obligations. Now we need to discuss a more robust situation—that of a fund manager. Our example fund is focused on Aluminum. The investors into the fund are themselves generally concerned with production. Accordingly, we have a large number of producers who generally invest into the fund when they believe that the price of aluminum is going up and less frequently invest into the fund when the price of aluminum is going down. Nevertheless, their investment into the fund is very dependent on their respective cash situation—so they will invest into the fund when they have excess cash—even if this will leave them holding an investment in the fund for longer than they would have if they were more focused on commerce and financial obligations. They place some of their excess cash into the fund because they appreciate that this investment represents insurance that they will be able to get a supply of aluminum—and this has an intrinsic value to them too.

On the other side, most producers have regular production schedules—so each time that they are looking to buy aluminum, they will either liquidate part of their fund investment or they will go directly to the aluminum market and buy aluminum. However, since the producer is not doing this as a speculator, it is unlikely that the producer will suddenly come back to the fund and sell off a large block—even if the instant profit might be large—because he remains a producer with his initial worry about having a constant supply that is more or less price stabilized.

Let's now sum up the situation for the funds manager. Producers generally buy into the fund when they have excess cash and/or when the price is anticipated to be going up. The producers then generally sell out of the fund when the fund gives them cheaper aluminum than the instant market price and/or when they do not have excess cash but can get supply from the fund. This means that the fund generally has more assets than it should rationally expect to have—because the producers will stay invested in the fund even when they anticipate a market price turn from going up to going down.

More particularly, the fund manager simply expects higher activity in anticipated market rising conditions, lower overall activity in anticipated market falling situations, and also higher activity during stable market periods when there are suspicions that the market may destabilize. This means that the fund manager knows that because of the nature of his investors, he will be holding more cash or aluminum-linked assets than he will need for short term delivery—because there is an intrinsic latency in the cash flow that goes through his fund. This latency may tempt the fund manager into a speculation mode. However, as a speculator, there is no reason that he cannot look to other commodities and other commercial transactions to best profit from his ongoing cash flow surplus. Accordingly, the fund manager really divides his task into two parts—(1) a market-sensitive part for meeting his irregular schedule to deliver production portions and (2) an on-paper part representing a longer-term eventuality that he will have to complete delivery (for example if he were to stop accepting investments).

What we would now like to do is to suggest some well-understood strategies to the fund manager whereby he can begin to calculate and market correlate his market-sensitive and on-paper parts. Collectively, his understanding of these calculations and market correlations will give him an advantage of scale over his individual producer investors.

Thus, one could suggest that the individual producer investors are motivated to participate in the fund in order to mitigate the risk of market instability—while the fund manager is motivated to participate in the fund in order to take profitable advantage of occasional discrepancies between the collective investor needs and the market reality. Symbolically, one may describe the producer/fund relationship as no-lose/win situation.

### Why a Centralized Fund can Create Savings

Let us examine why in fact if many individuals are in the position of our manager and need to guarantee their supply of aluminum, it may be advantageous for a single fund to cater to the need for “aluminum insurance.” The manager of the fund can generally duplicate the strategies of the individual investors without any loss (besides administrative cost), but he may also have opportunities for economies of scale, which will enable him to save his customers money and make a profit from administering the fund.

Here are some potential sources of economies of scale in running such a fund:

TRADING COSTS: Some purchases and sales of individual investors will cancel out, thus obviating the need for trades. Everyone is familiar with the case of small-scale currency traders who both buy and sell foreign currency to tourists; even if they charge the same amount as they themselves must pay to banks they can make money because much of their business is turnover. Furthermore, commissions may be less expensive for larger firms so that the firm can charge investors market rates and trade at a discount. Trades or deliveries of a number of investors may be consolidated thus saving on commissions.

RISK POOLING: Every investor in this fund is trying to reduce her risk. The fund manager must be certain to eliminate risk for each client. However, we can note that each client's risk is divided into two types: unique risk and market risk. Each client's unique risk is due to her special situation: an unexpected order, a cash shortfall, etc. For this reason they want to keep a surplus in the fund or pool rather than just wait until they need the aluminum and buy on the spot market. In addition, there is market risk, which is common to all investors. If the price of aluminum goes through the roof the fund is obligated to every investor to redeem their full investment stake.

“Unique” risk can be met with a small fraction of the total amount of outstanding shares—just as banks maintain reserves that are only a small fraction of outstanding deposits, knowing that there is no realistic chance that all depositors will seek their money at once. If this is the only type of risk facing investors, the fund manager may be able to insure hundreds of investors with a need for thousands of tons of aluminum, yet keep on hand at any time only enough aluminum or equivalent hedging instruments for a few dozens or hundreds of tons. The rest of the money can be invested in other investments, which can provide more yield and less risk. The condition is that the manager must find a way to hedge away the market risk, that is, the events which would involve all clients demanding their investment at once, much like a run on a bank.

INVENTORY MANAGEMENT: Having actual inventory of a commodity is not quite the same as having the ready cash to buy it. The two are most similar for a standard, widely traded commodity, yet even for these there are sources of divergence. As we mentioned above, inventory is costly because storage is expensive, but inventory can also be profitable because of the “convenience yield”, the need that can sometimes arise to have inventory on hand and not incur the wait and delivery costs of buying commodities on an exchange. Today there are very sophisticated inventory management schemes that balance these two aspects, and they provide very important economies of scale.

Consider: Ms. A is a single producer with a single warehouse. She will be able to realize a “convenience yield” only if she can identify someone in her immediate area who needs aluminum desperately; this is an “information cost”. And she will be able to accommodate the request only if she has spare inventory. By contrast, Mr. B is a fund manager. He may have thousands of tons of aluminum distributed in hundreds of dispersed warehouses. There is a saving in information cost, because many people know of his large fund and will turn to him if they need aluminum quickly and are willing to pay a premium. Likewise, spare inventory is not likely to be a problem because Mr. B has many customers and emptying out one warehouse still leaves his regional customers with many other options.

We can quantify these economies of scale with the use of some simple inventory management models. One of the most well-known models is the one used by William Baumol in 1952, which assumes that inventory is used up at a predictable, constant rate. This model gives the famous “square root” rule, where average inventories are the square root of the total amount of disbursements in the period. Thus, when total throughput doubles, for example by doubling the amount of investment in the fund, the amount of inventory increases only by about 40%, resulting in a great saving in holding cost. Transactions costs also increase only by the square root of throughput.

Another relatively simple model, which is slightly more realistic in our case, is the Miller Orr model published in 1966. In the Miller Orr model, inventories accumulate or get used up in random fashion. This more closely approximates the kind of fund we envision, where the fund manager does not really know when investors will decide to buy in or cash out. This model gives us a “tube root” rule, where mean inventories are inversely proportional to the cube root of the quantity. When doubling the investment, carrying costs and transactions costs increase only by the cube root of two, which is only about 26%.

However, the nature of our fund is that investors are buying into the fund to create a stable longer-term commodity price for their own production needs. We may posit that there is no mechanism for our fund's investors to sell out their investments into the fund—no matter how sharply the commodity price may be rising or falling. Our investors' simply look at their respective cash position, inventory management, and current spot price.

On the one hand, he will invest in the fund if he is in a cash surplus position where he believes that the intermediate to long-term spot market prices are to be erratic or rising. On the other hand, when the investor needs an instant quantum of the commodity, he will decide either to accept a transfer of ownership for the deliverable quantum of the commodity futures owned by the fund or he will go to the spot market to buy that quantum directly. He will come to the fund to collect a quantum of commodity (A) if he lacks other cash resources to buy that commodity on the spot market, or (B) if the fund price that he paid was appreciably lower than the current spot price, or (C) if he believes that the comparable value of quantum that he can collect from the fund will be declining in spot price equivalent value.

Thus, there is an innate latency (time delay) in the customer's fund redemption orders—because he can only collect by taking delivery—and this is directly related to the rate of demand that his production facility creates. Accordingly, (1) the fund may be relatively inactive during long periods where there is a perception by investors that the spot prices will be falling, (2) the fund will be relatively active during periods when the investor perspective is of an erratic or rising spot market price projection, but the fund will have an irrational elevated level of activity during transition periods where the long term investor perspective is shifting from rising or erratic market to a falling market.

Now, please note that in our situation, a producer (who bought a ton of aluminum via the fund) upon selling out of the fund, may either ask for the current market price for a ton of aluminum or for the actual physical ton of aluminum. By this we introduce a new degree of variability into the fund managers task—in that here too the trends and expectations in the market will cause more producers to ask for cash in lieu of commodity at some times and will cause more producers to ask for commodity in lieu of cash at other times. (Note: We presume that the delivery charges for the fund, that is accepting commodity on behalf of the producer, are exactly identical to the delivery charges that which the producer would himself pay.) This factor can be introduced to an inventory management program.

Market Risk

The main problem faced by the fund manager is that due to the presence of market risk, the degree of flexibility provided by the economies of scale we mentioned is quite limited. It's true that on any given day, the demand for liquidity is low, and so it is possible for the manager to keep a small amount of cash or metal on hand for day-to-day transactions, and leave the rest in longer-term instruments.

However, ultimately the manager has obligations equal to the total amount of outstanding aluminum “deposits” in his fund. His balance sheet must reflect this; if the price of aluminum doubles overnight (certainly not an unheard-of occurrence in commodities) the value of his portfolio must match the rise in aluminum prices.

This too is like the bank analogy we used before. It's true that a bank needs to keep only a small fraction of checking deposits in cash or equivalent, since there is no likelihood that all depositors will demand cash at once. However, the bank's balance sheet must always reflect a surplus; the bank can deposit most of the money in longer-term instruments, but it can't deposit them in instruments, which are not going to maintain solvency in any foreseeable contingency.

When it comes to this aspect of the fund management, economies of scale are small. Some options or future trades can be made in large blocks. This has the advantage of saving on commissions, but it also has the disadvantage that very large trades can be hard to fill, and they move the market. It's always possible to find a few hundred tons in the spot market or in financial instruments, but for much larger amounts the market may not be liquid—no partners may be found. Alternatively, partners may be found but the fund's very large demand may raise prices.

A fund, according to the present invention, generally takes money from investors and promises them delivery of a quantity of a predetermined commodity according to today's market price for that commodity; and the delivery is at an investor elected future date, which does not have to be specified greatly in advance of the delivery. (We will not address aspects of the actual delivery at this stage nor aspects of costs associated therewith.) One of the things that the present invention wants to explain is how a fund manager will take advantage of the peculiarities of the cash flow through his fund. Lets sum up some of these peculiarities. First, investors to the fund are actual commodities consumers—meaning they need the physical commodity for their respective operations. Thus, even if they appreciate many of the nuances of the commodity market behavior, even to the level of potentially being successful commodity speculators, they will not use the fund as a vehicle for speculation. This means that they will not sell blocks of their fund investment substantially larger than the ordinary needs of their respective industrial facilities. However, they may take modest advantage of any surplus commodity storage space that they have to nominally improve their benefits from the fund. (2) The ordinary investor buys into the fund when he has a cash surplus and/or when he believes that the price of the commodity is going up. Of course he may be wrong in his expectation that the price will go up—but he knows that he will at least be able to get the commodity in the future from the fund according to today's price—so he considers this a good backup supply of commodity for his industrial facility. (3) The ordinary investor will sell out of the fund when he is in a cash limited situation an/or when he believes that the price of the commodity is going down. Again, he may be wrong about his expectations that the price will go down, but at least he is taking delivery for a commodity that he uses in his industrial facility. Of course, even if he is correct that the price is going down, he will not sell off from the fund faster than he can use and/or store the commodities received from the sale.

Now, for the fund's manager, the ordinary situation is that (1) there are ongoing buys and take deliver sells when the market is going up, (2) there are ongoing sells and some buys when the market is going down, (3) for inversions between an upward market and a downward market—there is a lag of sells that provide simple residual profit into the fund, and (4) for inversions between a downward market and an upward market—there are more fund buys than fund sells.

Nevertheless, as producers increasingly come to use the fund as a vehicle for stabilizing their ability to get commodity delivery, the fund will find itself with an increasing inventory of commodity that is not needed to meet any proximate foreseeable sells—so the fund may begin to convert all or part of this latent commodity into other types of investments—be they speculative investment in the market of the commodity per se or investments in other areas.

This understanding of investor motivation deepens the analogy we drew before between a commodity fund and a bank. We pointed out above that a bank needs to keep on hand, in cash or cash equivalent, only a small fraction of the amount of demands deposits it accepts. This creates an opportunity for profit, because the bank pays no interest, or very low interest, on its demand deposits, yet is able to use over 90% of the money for less liquid investments, which provide a much higher yield.

In the same way, our commodity bank is not paying investors any interest on their “deposits” of aluminum. It needs to keep on hand only a small amount of the total quantity of aluminum it owes to investors, and it will be able to use the vast majority of the money for less-liquid investments which provide a significant return.

The reasons for the low reserve ratio are likewise similar. One reason banks need only a small fraction of reserves is that customers' needs for money are individually unpredictable. Even if customers manage their cash in an aggressive way to minimize their cash balances, as is done when interest rates are high, inherent unpredictability obligates them to keep cash balances; each customer's needs are different and so the bank as a whole needs small balances. The second reason is that many customers are very lazy in their cash management. They are comfortable knowing that they have money in the bank for a rainy day, and they are not concerned with constantly finding the best investment and moving their cash around.

Likewise, our fund investors have unpredictability in their commodity needs. Even if they have aggressive inventory management, they will need to keep some positive balance in the fund, and the needs of individual investors will cancel out. In addition, many investors will not be interested in aggressive asset management and will be content to sit on their balances.

Now we move on to a variation of the fund, according to the present invention, where the buyer buys shares in the fund according to today's price of a base commodity—however the buyer, when he sells these shares, may take delivery of either the commodity per se OR of a similar commodity. Here the fund manager regularly re-sets the take deliver differential between the base commodity and the similar commodity.

Let's say that the base commodity is aluminum-A and the “similar” commodity is aluminum-B. The fund manager may say that the buyer can take deliver in aluminum-A as in the regular fund; or if the buyer wants to take deliver of aluminum-B, then the fund delivery of aluminum-B is according to the date-of-delivery ratio between the prices of aluminum-A and aluminum-B. Thus, if the price of aluminum-B is 90% the price of aluminum-A on the sale date, then the fund will deliver 90% quantity of aluminum-B; or perhaps some nominal amount less—since it is likely that the fund (which is linked to aluminum-A) will either charge a slight fee or a slight fraction of a percentage to discourage taking permissible delivery in aluminum-B.

Further embodiments of the instant invention relate to a facile memory media having securely encrypted thereon prepaid barter credit for a predetermined fungible commodity and the credit is directly linked to a quantity of the commodity proportional to a relationship between a unit price paid for the credit and a current standard unit price for the commodity; and the commodity price is selected from the list: wholesale price, futures price, regional price, national price, and international price; wherein acceptance of delivery of any portion of a physical commodity corresponding to the respective barter credit requires payment of peripheral charges therewith, and the peripheral charges relate to accepting the portion; and the charges are selected from the list: storage fee, marketing fee, transportation fee, transaction processing fee, refining fee, delivery fee, shrinkage fee, local tax, state tax, and federal tax.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I/we claim:

1. A transaction payment method, comprising the steps of:
(a) electronically accepting, by a secure central transaction processor, a transaction request to purchase a quantity of a fungible commodity, the transaction request comprising:
(i) a first group of data concerning the authorization of a customer account,
(ii) a second group of data concerning the authorization of a retailer account,
(iii) a third group of data describing a quantity of a fungible commodity being delivered by a retailer associated with the retailer account to a customer associated with the customer account, and
(iv) a fourth group of data quantifying a service charge associated with a sale of the quantity of the fungible commodity;
(b) validating, by the processor, the first group of data and the second group of data;
(c) electronically transferring, by the processor, the quantity of the fungible commodity described by the third group of data from the customer account to the retailer account; and
(d) electronically transferring, by the processor, an amount of cash quantified by the fourth group of data, from the customer account to the retailer account.

2. The transaction payment method of claim 1, wherein the quantity contained in the transaction request is a metric selected from the group consisting of: number, volume, weight, energy content, and nutritional content; and the commodity contained in the transaction request is selected from the group consisting of: crude oil, heating oil, aviation fuel, diesel engine fuel, internal combustion engine fuel, hybrid engine fuel, bio-fuel, natural gas, methane, propane, acetylene, a liquefied gas, a petroleum refinery product, a precious metal, a strategic metal, bottled water, and a commercially traded commodity having an ongoing short term or medium term or long term futures price on a government regulated commodities exchange.

3. A transaction payment instrument, for use in an electronic communications facilitated transaction for purchasing a retail quantity of a fungible commodity, comprising:
(a) a memory media having securely encoded thereon:
(i) a prepaid commodity portion that represents an account containing a credit for a quantity of the fungible commodity, and
(ii) a promissory portion that is equivalent to cash.

4. The transaction payment instrument of claim 3, wherein the memory media further comprises at least one item from the group consisting of: general customer account authorization data, customer account authorization data specific to an account containing a credit for a predetermined quantity of the fungible commodity; and customer account authorization data specific to an account used for making payment of a promissory cash-equivalent demand.

5. The transaction payment instrument of claim 3, wherein the memory media is selected from the group consisting of: radio-frequency identification tag, credit card, secure data storage card, printed coupon, and biometric measurement device.

6. The transaction payment instrument of claim 3, wherein the promissory portion that is equivalent to cash is tied to a monetary instrument having an ongoing short term or medium term or long term futures price and having an ongoing linkage with a national or international currency.

7. A transaction payment method for exchanging a commodity using a transaction payment instrument, comprising the steps of:
(a) presenting, by a buyer, a transaction payment instrument comprising:
(i) a prepaid commodity portion that represents an account containing a credit for a quantity of the commodity, and
(ii) a promissory portion that is equivalent to cash,
(b) accepting, by a seller, said instrument;
(c) requesting, by the buyer, a quantity of the commodity;
(d) deducting, by the seller, from the instrument:
(i) a credit for a quantity of the commodity corresponding to the quantity requested, and
(ii) an amount equivalent to cash and corresponding to a bundled cost associated with the sale of the quantity of the requested commodity, wherein the bundled cost is selected from the group consisting of: profit, a marketing charge, a delivery charge, a service charge, a storage charge, tax, a processing charge, and a difference between the prepaid price represented by the prepaid commodity portion and a current retail price for the requested commodity; and
(e) delivering, by the seller, the requested quantity of the commodity to the buyer.
